(19) United States
(12) Patent Application Publication
(10) Pub. No.: US 2021/0309222 A1
(43) Pub. Date: Oct. 7, 2021

(54) METHOD AND DEVICE FOR DEACTIVATING AND REACTIVATING AN ACTIVATED DISTANCE- AND/OR SPEED-CONTROL SYSTEM

(71) Applicant: Robert Bosch GmbH, Stuttgart (DE)

(72) Inventors: David Huebner, Kornwestheim (DE); Michael Schoenherr, Renningen-Malmsheim (DE)

(21) Appl. No.: 17/127,013

(22) Filed: Dec. 18, 2020

(30) Foreign Application Priority Data
Apr. 7, 2020 (DE) 102020204468.6

(51) Int. Cl. B60W 30/14; B60W 40/08; B62J 45/20

(52) U.S. Cl. CPC B60W 30/143; B60W 40/08; B60W 2540/10; B60W 2300/36; B62J 45/20

(57) ABSTRACT

A method and a device for deactivating and reactivating an activated distance- and/or speed-control system of a motor vehicle. In the method, the activated distance- and/or speed-control system is deactivated by predetermined operation of a first control element, and the activated distance- and/or speed-control system is activated again or reactivated by predetermined operation of a second control element done twice. Upon deactivation, set variables of the distance- and/or speed-control system, e.g., the set speed, are stored at the same time, and are set again upon the reactivation.

### CROSS REFERENCE

The present application claims the benefit under 35 U.S.C. § 119 of German Patent Application No. DE 102020204468 filed on Apr. 7, 2020, which is expressly incorporated herein by reference in its entirety.

### BACKGROUND INFORMATION

German Patent Application No. DE 10 2018 214 421 A1 relates to a method for switching from a first driver-assistance function to a second driver-assistance function in the case of a single-track motor vehicle, one of the driver-assistance functions being an adaptive distance- and speed-control function and the other driver-assistance function being a cruise-control function, the switchover being effected by uninterrupted operation of a control element over a time interval of predetermined length by the driver.

### SUMMARY

The present invention relates to a method for deactivating and reactivating an activated distance- and/or speed-control system of a motor vehicle. In accordance with an example embodiment of the present invention, in the method:
the activated distance- and/or speed-control system is deactivated by predetermined operation, especially one-time operation, of a first control element and
the activated distance- and/or speed-control system is activated again or reactivated by predetermined operation of a second control element done twice.

Upon deactivation, set variables of the distance- and/or speed-control system, e.g., the set speed, are stored at the same time, and are set again upon the reactivation.

In one advantageous embodiment of the present invention, the first control element and the second control element are identical, this control element being operated once for the deactivation, and the control element in each case being an engine-torque demand element.

In one advantageous embodiment of the present invention, the motor vehicle is a single-track motor vehicle.

In one advantageous embodiment of the present invention, the control element is the throttle twist grip of the single-track motor vehicle.

In one advantageous embodiment of the present invention, the predetermined operation is an overtwisting.

In one advantageous embodiment of the present invention, in that in the case of the twice-done predetermined operation of the control element, both operations must be carried out within a time interval of predetermined length.

In one advantageous embodiment of the present invention, the single-track motor vehicle is a motorcycle.

In addition, the present invention includes a device containing a device which are designed to carry out the method of the present invention. In particular, it is a control unit in which the program code for carrying out the example method(s) according to the present invention is stored.

### BRIEF DESCRIPTION OF THE DRAWING

FIG. 1 shows the functional sequence of one example embodiment of the method according to the present invention.

### DETAILED DESCRIPTION OF EXAMPLE EMBODIMENTS

The present invention concerns the development of an intuitively operable switch-over method, with whose aid the driver of a motor vehicle is able to activate and deactivate a distance- and/or speed-control system, without becoming distracted from the traffic situation and the guidance of the vehicle. Using a single-track motor vehicle as an example, the deactivation may be accomplished by overtwisting the throttle twist grip one time, and the reactivation by overtwisting the throttle twist grip twice or two times within a brief predetermined time interval.

An intuitive operative control of the function is thereby made possible. The driver does not have to remove his hand or individual fingers from the handlebar in order to resume the CC/ACC, and thus may concentrate fully on the guidance of the vehicle.

This is explained on the basis of the following practical example. When a motorcycle enters into a curve, by maintaining a constant speed with the distance- and/or speed-control system active, a strange riding sensation may develop. For this reason, in many cases the distance- and/or speed-control function is stopped when entering into a curve or in the middle of a curve. In this context, in order not to introduce any unwanted forces, and therefore disquiet, into the chassis and suspension due to actuation of the brake, a stop function may be utilized by overtwisting the throttle twist grip.

The typical behavior when exiting a curve is to accelerate out of the curve. This may be accomplished by resumption of the distance- and/or speed-control function, which accelerates the vehicle again to the previously selected driving speed. Operation of the main switch of the function would necessitate removing a hand or individual fingers from the handlebar. Resumption by overtwisting the throttle twist grip twice would prevent this and would be an intuitive operating concept based on the stop function. This also contributes to a more dynamic ride, since the resumption may be accomplished more quickly and with the gas hand, resulting in enhanced comfort and convenience when using the distance- and/or speed-control system, and increased user acceptance.

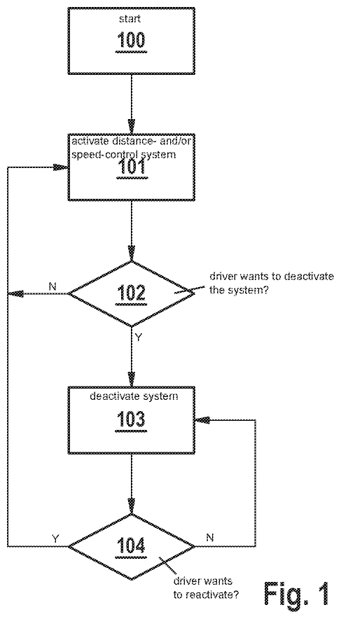

FIG. 1 shows the functional sequence of one embodiment of the method according to the present invention. After the start in block 100, in block 101, a distance- and/or speed-control system is activated, and the driver is given the opportunity to select the set speed, for example. If a distance-control system is available, the speed may then also be adjusted as a function of the distance to a preceding vehicle.

Subsequently in block 102, it is checked whether the driver wants to deactivate the system. For example, this may be accomplished by checking whether the throttle twist grip has been overtwisted one time. If the driver does not want to deactivate the system, there is then a return back to block 101. However, if the driver wants a deactivation, the system is then deactivated in block 103. In block 104, it is checked whether the driver wants to reactivate the system. For example, this may be accomplished by overtwisting the throttle twist grip twice within a brief predetermined time interval.

If this is the case, there is then a return to block 101. If the driver does not want a reactivation, there is a return to block 103.

What is claimed is:

1. A method for deactivating and reactivating an activated distance- and/or speed-control system of a motor vehicle, the method comprising the following steps:
deactivating the activated distance- and/or speed-control system by a predetermined operation of a first control element; and
after the deactivating, reactivating the deactivated distance- and/or speed-control system by the predetermined operation of a second control element performed twice.

2. The method as recited in claim 1, wherein the first control element and the second control element are the same control element, wherein the control element is operated once for the deactivation, and wherein the control element is an engine-torque demand element.

3. The method as recited in claim 2, wherein the motor vehicle is a single-track motor vehicle.

4. The method as recited in claim 3, wherein the control element is a throttle twist grip of the single-track motor vehicle.

5. The method as recited in claim 4, wherein the predetermined operation is an overtwisting.

6. The method as recited in claim 5, wherein for the twice-performed predetermined operation of the control element, both are carried out within a time interval of predetermined length.

7. The method as recited in claim 3, wherein the single-track motor vehicle is a motorcycle.

8. A device, comprising:
a control unit configured to deactivate and reactivate an activated distance- and/or speed-control system of a motor vehicle, the control unit configured to:
deactivate the activated distance- and/or speed-control system based on a predetermined operation of a first control element; and
after the deactivation, reactivate the deactivated distance- and/or speed-control system by the predetermined operation of a second control element performed twice.
